(19) United States
(12) Patent Application Publication
(10) Pub. No.: US 2019/0248233 A1
(43) Pub. Date: Aug. 15, 2019

(54) DRIVE MODULE

(71) Applicant: The University of Sydney, Sydney, New South Wales (AU)

(72) Inventors: Mark Calleija, Rydalmere (AU); Salah Sukkarieh, Kogarah (AU)

(21) Appl. No.: 16/310,252

(22) PCT Filed: Jun. 16, 2017
(86) PCT No.: PCT/AU2017/050612

§ 371 Date: Dec. 14, 2018

(30) Foreign Application Priority Data
Jun. 17, 2016 (AU) 2016902371

(51) Int. Cl. B60K 17/34; B60B 27/00; B60B 35/12; B60K 17/30; B62D 5/04; B60B 33/00; B60B 37/10

(52) U.S. Cl. CPC B60K 17/358; B60B 27/0021; B60B 35/124; B60K 2007/0084; B62D 5/0418; B60B 33/0002; B60B 37/10; B60K 17/303

(57) ABSTRACT

This invention relates to a drive module. The drive module includes a base and a steering assembly rotatably mounted to the base. The steering assembly is selectively rotatable about a predetermined steering axis and carries a drive train. The drive train is configured to provide a multi-stage drive reduction of the drive train and the drive train is adapted to support a wheel such that a centre of a contact patch of the wheel is laterally offset from the steering axis.

### FIELD OF THE INVENTION

The present invention relates generally to drive modules. The invention has been developed more particularly for use as a swerve drive module for use with mobile platforms and vehicles in applications such as in connection with agricultural, mining, defence, education, research, medical practice, space, logistics, urban and domestic robots and will be described predominately in this context.

It should be appreciated, however, that the invention is not limited to these fields of use, being potentially applicable in a wide variety of applications where a highly manoeuvrable vehicle or mobile platform is advantageous, including in the field of personal transportation.

### BACKGROUND TO THE INVENTION

The following discussion of the prior art is intended to place the invention in an appropriate technical context and enable its advantages to be more fully appreciated. However, any references to prior art throughout this specification should not be construed as an express or implied admission that such art is widely known or is common general knowledge in the relevant field.

Various drive modules for vehicles and movable platforms are known, including for omni-directional motion for autonomous systems. Autonomy is being adapted within cars, trucks, robotics, transporters etc. more and more. Such systems are increasingly becoming smarter and this giving rise to an increased reliance and use of autonomous systems and related devices. Omni-directional motion is an important feature for such autonomous systems because it reduces path planning dependencies, and provides additional functionality in terms of sideways motion and the ability to turn “on the spot”.

One such device that can be used in autonomous systems is a so-called swerve drive. However, swerve drives are typically heavy, slow, relatively complex and difficult to build, have a large swept volume and thus relatively expensive devices. In addition, swerve drives are generally only suitable for limited applications, whereas there is vast potential for many and varied applications of autonomous systems.

It is an object of the present invention to overcome or ameliorate one or more of the disadvantages of the prior art, or at least to provide a useful alternative.

### SUMMARY OF THE INVENTION

According to one aspect of the invention, there is provided a drive module, including:

a base;

a steering assembly mounted to the base and selectively rotatable about a steering axis;

a drive train carried by the steering assembly; and

a wheel operatively associated with the drive train;

wherein at least a portion of the steering assembly and the drive train is spaced from the steering axis, thereby to form a void about the steering axis in which the wheel can be mounted.

Preferably, the drive train provides a drive reduction from an input end of the drive train to an output end of the drive train. In some embodiments, the drive train provides a single stage drive reduction. In other embodiments, the drive train provides a multi-stage (two or more) drive reduction.

Preferably, the wheel is mounted to the drive train such that a centre of a contact patch of the wheel is laterally offset from the steering axis.

According to another aspect of the invention, there is provided a drive module, including:

a base;

a steering assembly rotatably mounted to the base, the steering assembly being selectively rotatable about a predetermined steering axis;

a drive train carried by the steering assembly, the drive train being configured to provide a multi-stage drive reduction;

wherein the drive train is adapted to support a wheel such that a centre of a contact patch of the wheel is laterally offset from the steering axis.

In the context of this specification, the term “lateral offset” is intended to refer to a displacement in a sideways direction relative to the line of travel of the wheel (i.e. when the vehicle is viewed from the front or rear). In some embodiments, the width of the wheel may be such that the extent of lateral offset ensures that there is no overlap between the wheel (e.g. side wall) and the steering axis. In other embodiments, the extent of the lateral offset may be such that there is a degree of overlap between the wheel and the steering axis.

It is particularly advantageous to configure the drive module such that at least a portion of the drive train and/or the steering assembly is spaced from the steering axis to form an open area or void about the steering axis in which the wheel can be mounted. This ensures that the wheel can be readily mounted in a manner in which no portion of the steering assembly or the drive train interfere with the wheel, particularly the upper top half of the wheel. This arrangement also ensures that one or more of the components of the drive train responsible for transmitting driving torque to the wheel is/are similarly offset such that torque is not transmitted directly down along the line of the steering shaft axis to the wheel hub. Rather, one or more components of the drive train (e.g. the torque transmission element or elements), when viewed from top to bottom, is/are offset laterally to provide the void about the steering axis. Because the central column about the steering axis is effectively vacant in this region, this provides an open space for wheel sidewall clearance and/or, more generally, for at least a portion of the wheel to occupy, thereby advantageously resulting a relatively compact and robust design structure of the drive module. Notably, the overall footprint of the drive module can be reduced whilst still mounting the wheel in a laterally offset position.

In some embodiments, the drive module is adapted for use as part of a swerve drive unit having omni-directional functionalities and capabilities. Accordingly, the steering assembly is preferably mounted to the base so as to be continuously rotatable (i.e. through 360 degrees or more) relative to the base about the steering axis, whereby rotation of the steering assembly about the steering axis causes a corresponding rotation of the wheel about the steering axis such that the wheel rolls about its axis of rotation (e.g. as defined by a drive shaft). Preferably, the steering assembly can rotate both in a clockwise direction and a counter-clockwise direction about the axis of rotation (when viewed from above), as desired.

In some embodiments, the drive train is in the form of a mechanical gear arrangement configured to provide drive reduction, and preferably a multi-stage (two or more stage) drive reduction from a drive actuator to the wheel. In certain embodiments, the drive train is configured to provide a two-stage drive reduction, wherein a first gear set is associated with an input driving actuator and provides a first stage drive reduction, and a second gear set is associated with an output driven member and provides a second stage drive reduction of the drive train. It will be appreciated that the multi-stage drive train carried by the steering assembly is not limited only to such two stage reduction configurations. In other embodiments, the drive train carried by the steering assembly may be configured to include three, four, five or more stages of reduction.

In other embodiments, the drive train may include transmission elements other than, or as well as, gears, including for example, belts, pulleys, flexible shafts and the like, or combinations thereof.

In certain embodiments, an auxiliary drive reduction mechanism may be provided between the driving actuator and the drive train carried by the steering assembly, thereby to provide a further drive reduction from the driving actuator to the output driven member. In some embodiments, the auxiliary drive reduction mechanism may be releasably mounted between the driving actuator and the steering assembly such that it is selectively interchangeable, whereby an auxiliary drive reduction mechanism configured to provide a different reduction ratio can be fitted to the drive module as required.

Preferably, the drive train includes a first (top) gear set having a pair of spur gears arranged and configured to be rotatably driven by a driving actuator. The first (top) gear set includes a first spur gear meshingly engaged with a second spur gear such that rotation of the first spur gear in a first direction causes a corresponding rotation of the second spur gear in an opposed second direction.

Preferably, the axis of rotation of the first spur gear is coaxially aligned with the axis of rotation of the driving actuator (e.g. a shaft of a drive motor), thereby defining the steering axis about which the steering assembly rotates. The first and second spur gears are preferably mounted to the steering assembly such that each gear lies in a generally horizontal plane, with the steering axis extending in a generally vertical direction.

The first gear set is preferably arranged such that the axis of rotation of the first spur gear is in parallel spaced apart relation to the axis of rotation of the second spur gear.

Preferably, the drive train includes a second (bottom) gear set having a pair of gears arranged and configured to be rotatably driven by the first (top) gear set. In various embodiments, the second gear set may be driven directly or indirectly by the second spur gear. The second (bottom) gear set preferably includes a bevel gear set. Preferably, the bevel gear set has a first bevel gear arranged in parallel spaced apart relationship from the second spur gear of the first gear set, and a second bevel gear meshingly engaged with the first bevel gear.

In some embodiments, a connecting rod or shaft of a predetermined length is connected to and extends between the second spur gear of the first (top) gear set and the first bevel gear of the second (bottom) gear set, wherein the second spur gear, the connecting rod and the first bevel gear rotate in unison about a common axis.

Preferably, the bevel gear set is configured such that the axis of rotation of the second bevel gear is orthogonal to the axis of rotation of the first bevel gear, and thus that of the connecting rod and the second spur gear (and also that of the first spur gear and steering axis).

Preferably, the first (top) gear set has a first drive reduction ratio (R₁). The first drive reduction ratio is determined by reference to the number of teeth on the first spur gear (n₁) and the number of teeth on the second spur gear (n₂).

Preferably, the second (bottom) gear set has a second drive reduction ratio (R₂). The second drive reduction ratio is determined by reference to the number of teeth on the first bevel gear (n₃) and the number of teeth on the second bevel gear (n₄).

In some embodiments, the first drive reduction ratio of the first gear set is greater than the second drive reduction ratio of the second gear set. In other embodiments, the first drive reduction ratio of the first gear set is less than the second drive reduction ratio of the second gear set. In certain embodiments, the first drive reduction ratio and the second drive reduction ratio may be equal to one another.

Preferably, the drive train has an output driven member for supporting the wheel (or other moving member such as, for example, roller, track, etc). The output driven member is preferably a drive shaft adapted for rotation about its longitudinal axis by actuation of the drive train. Preferably, the drive shaft is affixed to, and co-rotates with, the second bevel gear. The drive shaft and second bevel gear are preferably coaxially aligned with one another, and thus with the axis of rotation of the wheel.

The second bevel gear preferably has a bore and the drive shaft is connected to the second bevel gear such that the drive shaft extends at least partially through the bore. In some embodiments, the bore is a through bore and the drive shaft is mounted so as to extend through the bore, wherein a first end of the drive shaft is adapted to support the wheel and an opposed second end of the drive shaft is supported by a bearing mounted within the steering assembly. The drive shaft preferably extends through the bore such that the first and second ends of the drive shaft are positioned on opposite sides of the second bevel gear. In some embodiments, the drive shaft is connected to the second bevel gear and the wheel by a power transmission element (e.g. a mechanical key) such that the draft shaft, the second bevel gear and the wheel co-rotate in unison about a common axis (i.e. the “wheel axis”).

In some embodiments, the output/second bevel gear of the drive train is arranged between the connecting shaft and the wheel, thereby providing a compact arrangement to the drive module. In other embodiments, the output gear may be positioned on the opposite side of the connecting shaft with respect to the wheel.

In some embodiments, the steering assembly includes a steering arm mounted for rotation relative to the base. Preferably, the steering arm has a receiving formation in which the drive train can be mounted, whereby the steering arm acts as a mechanical support for the drive train to maintain the relative positioning and alignment of the drive train components. The first gear set, second gear set and connecting rod of the drive train are preferably housed entirely within the steering arm, whereby the steering arms act as a cover for the drive train protecting the geared mechanism from dust and debris.

In certain embodiments, the steering arm is a single-arm configuration adapted to support the wheel to one side of the steering arm. In some embodiments, the steering arm has an asymmetrical profile, thereby enabling the wheel to be laterally offset from the steering axis. In some embodiments, the steering arm is a generally L-shaped member. Preferably, the L-shaped member has a first arm at its proximal end and adapted to be mounted in close proximity to the base, and a second arm extending at a predetermined angle from the first arm to its distal end. The second arm of the L-shaped steering arm preferably extends orthogonally to the first arm.

In some embodiments, the length of the first arm is less than the length of the second arm. In some embodiments, the length of the first arm is greater than the length of the second arm. In some embodiments, the length of the first arm is substantially equal to the length of the second arm.

In certain embodiments, the first gear set is housed within the first arm at the proximal end of the steering arm, and the second gear set is housed towards the distal end of the second arm of the steering arm, wherein the connecting rod extends between the first and second gear sets along the second arm.

It will be appreciated that the steering arm is not limited to such single arm configurations and may take any suitable structural form which enables the wheel to be mounted with the centre of the contact patch of the wheel laterally offset from the steering axis. For example, the steering arm could be a dual-arm forked arrangement, wherein the wheel is supported between two fork arms elements.

In some embodiments, the length of the steering arm and/or connecting rod may be selectively adjustable. In certain embodiments, the steering arm may be telescopically extensible in order to adjust the effective length of the second arm. The connecting rod may be similarly telescopically extensible in order to accommodate adjustments to the effective length of the second arm. In other forms, the length of the steering arm and/or connecting rod may be adjustable by selectively installing or removing discrete extension elements at predetermined joining locations and suitable attachment means.

In one embodiment, the steering arm and connecting rod is adjustable on the fly, in response to control inputs from a control system, to assist the drive module to navigate obstacles, varying terrain conditions, and/or path optimisation. The steering arm may also incorporate suspension elements to accommodate a degree of passive or active height adjustment as the drive module traverses obstacles or rough terrain, as well as to reduce and isolate the unsprung mass of the vehicle.

Preferably, a control unit is provided for selectively controlling movement of the drive train and steering assembly. The control unit preferably has a drive module or system for controlling movement of the drive train, the drive module including a driving actuator adapted to provide drive inputs to the drive train, thereby propelling the wheel in a forwards or a reverse direction as required. The control unit preferably has a steering module or system for selectively controlling movement of the steering assembly, the steering module including a steering actuator adapted to provide steering inputs to the steering assembly, thereby steering the wheel in a left or right direction. Advantageously, the drive module and steering module are operated independently such that the driving module can provide driving inputs whilst the steering module is in an inactive state. Similarly, the steering module can provide steering inputs whilst the driving module is in an inactive state. It will be appreciated that, by this arrangement, the driving and steering systems are advantageously decoupled from a mechanical perspective.

Preferably, the drive module includes at least a drive motor. In one embodiment, the drive motor is an electric motor. The drive module preferably includes a battery for the motor. It should be appreciated, however, that alternative sources of motive power may be used, including hydraulic or pneumatic motors, as well as petrol, diesel or LPG engines. In some embodiments, the drive module may include hollow bore motors (e.g. direct drives, harmonic drives, etc) or other hollow drive means (e.g. belt drives, chain drives etc), thereby to enable use of a hollow or concentric drive and/or steer motor configuration. It will be appreciated that in this configuration, a braking mechanism for the wheel (e.g. disc brakes) can be provided by transmitting a hydraulic or mechanical braking force through a freely rotatable joint arranged concentrically with the steering axis. In some embodiments, a braking force for the drive axis can be applied at or near one or both sides of the drive motor or an attached gearhead.

In some embodiments, the drive module preferably also includes computerised control modules, power regulators and/or associated electronic components, operating in accordance with predetermined drive control algorithms and methodologies. In one exemplary control methodology, the steering controller is configured to plan and control the steering motor in the direction that provides the shortest angular path between the actual or current steering angle position and the demanded or next steering angle position.

In some embodiments, the drive motor has a drive motor shaft which is coaxially aligned with, and operatively connected to, the first spur gear of the first (top) gear set, wherein rotation of the drive motor shaft by the drive motor causes a corresponding rotation of the first spur gear (and thus the wheel via the drive train). Preferably, the drive motor shaft is coupled to the first spur gear by a connecting member. In certain embodiments, the connecting member is in the form of a rigid connecting rod with a first end affixed to the drive motor shaft (e.g. by way of a mechanical key or spline arrangement) and second end affixed to the first spur gear (e.g. by way of a mechanical key or spline arrangement), thereby to effect suitable power transmission from the drive motor through the drive train to the wheel, thereby to propel the drive module.

Preferably, the steering module includes at least a steering motor. In one embodiment, the steering motor is an electric motor. The steering module preferably includes a battery for the motor. In some embodiments, the steering module includes a reduction gearbox associated with the steering motor. Preferably, the reduction gearbox of the steering module has a steering shaft for driving a steering gear mechanism, thereby to control movement (rotation) of the steering assembly.

The steering gear mechanism is preferably arranged within the base of the drive module, and is adapted to provide a further drive reduction to facilitate control of the steering assembly. In some embodiments, the steering gear mechanism includes a pair of steering spur gears mounted in intermeshing engagement so as to rotate in opposite direction to each other, the pair of steering spur gears including a first steering gear operatively coupled to the steering shaft such that, upon activation of the steering motor, rotation of the steering shaft causes a corresponding rotation of the first steering gear, and a second steering gear driven in an opposite direction to the first steering gear, wherein the second steering gear is operatively coupled to the steering assembly to cause a corresponding movement thereof. Preferably, the axis of rotation of the first steering gear is in parallel spaced apart relation to the axis of rotation of the second steering gear.

In some embodiments, the second steering gear is connected to the steering assembly by a coupling element, the coupling element being fixedly connected at one end (e.g. proximal end) to the second steering gear and at its other end (e.g. distal end) to the steering assembly, more preferably to the first arm of the L-shaped steering arm, such that the second steering gear, the coupling element and the steering assembly form an interconnected unit in which all components rotate in unison about the steering axis upon activation of the steering motor.

Preferably, the second steering gear and the coupling element are mounted (within the base) so as to be coaxially aligned with the steering axis (i.e. as defined by the drive motor shaft). In some embodiments, the coupling element is in the form of a hollow tubular member having a passage through which the connecting member of the drive module passes, thereby facilitating the coaxial alignment of the various components with the steering axis.

In some embodiments, the base has an open passageway defined about the steering axis and arranged to allow the coupling element of the steering module to pass therethrough. Preferably, one or more friction reducing elements (e.g. bearings) may be mounted within the open passageway to facilitate relative rotation between the base and the coupling element/steering assembly.

In some embodiments, the steering module preferably also include computerised control modules, power regulators, feedback encoders and/or associated electronic components, operating in accordance with predetermined steering control algorithms and methodologies.

Preferably, the various components of the drive and steering modules are mounted to a mounting board, thereby forming a control unit which can be releasably mounted to the base by suitable fastening means. In some embodiments, a protective cover or housing is detachably mountable over the control unit.

It will be appreciated that the wheel offset advantageously enables the wheel to roll about its axis of rotation, which is preferably defined by the longitudinal axis of the drive shaft, upon activation of the steering motor when the drive train is inactive. The lateral offset between the steering axis and the centre of the contact patch of the wheel advantageously allows the wheel to roll (as opposed to skid) when the steering assembly is rotated about the steering axis whilst no drive input is applied to the wheel via the drive train (and any braking mechanism is released such that wheel is free to rotate about its drive axis).

Preferably, the amount of offset between the steering axis and the centre of the contact patch of the wheel is less than the radius of the wheel. In other embodiments, the offset between the steering axis and the centre of the contact patch of the wheel is greater than the radius of the wheel.

It has been found that the following general kinematic equation can be used to calculate the preferred offset between the steering axis and the centre of the contact patch of the wheel, thereby defining the system geometry for the multi-gearset configuration of the drive train and the steering assembly:

$$\frac{{d}_{offset}}{{r}_{wheel}} = {\prod }_{i = 1}^{{n}_{gearsets}} \frac{{n}_{teeth \_ i \_ input}}{{n}_{teeth \_ i \_ outpu t}} = {R}_{final}$$

where:
d_{offset} is the offset between the steering axis and the centre of the contact patch of the wheel
r_{wheel} is the radius of the wheel
n_{gearsets} is the number of gearsets mounted on the steering assembly and is equal to or greater than 1 (i.e. n_{gearsets}≥1)
n_{teeth_i_input} is the number of teeth on the ith gearsets input gear
n_{teeth_i_output} is the number of teeth on the ith gearsets output gear
R_{final} is the final speed ratio of the multi-gearset configuration

Advantageously, the above equation is that n_{gearsets} is defined as only the number of gearsets of the drive train that are actually mounted to the steered assembly. The gearsets that are mounted to the non-steered mount point of the drive system are independent of the system geometry. In the case where one element of a gearset is mounted to the steered assembly whilst another element is mounted to the non-steering mount point of the drive system, such a gearset is taken to be included in the gearsets mounted on the steering assembly.

In the example of a drive train having two gear sets, the above general equation can be expressed as follows:

$$\frac{{d}_{offset}}{{r}_{wheel}} = \frac{{n}_{teeth \_ 1 \_ input}}{{n}_{teeth \_ 1 \_ outpu t}} \times \frac{{n}_{teeth \_ 2 \_ input}}{{n}_{teeth \_ 2 \_ outpu t}}$$

However, there may be imperfections and nonlinearities (e.g. in the tyre to ground interaction, manufacturing errors, tyre deformation etc.) which introduces error into the above simple kinematic equations and hence in practice. For example, with a given wheel construction with an estimated or predicted degree of deformation, the above formula could be modified or approximated to account for a difference between unloaded and loaded radius values, where the radius of the wheel in the formula is taken to be the loaded radius. That is, in the above formula, r_{wheel} may be replaced with:

r_{loaded}=r_{unloaded}−y_{deformation}
where y_{deformation} is the estimated deformation of the wheel.

In some cases, a more detailed mathematical model may be used to estimate the system geometry. In other cases, an empirical determination of the system geometry based on experimentation and measurement may produce more practical results for the present invention. Thus, it may be preferred in some embodiments to choose or refine the system geometry values d_{offset}, r_{wheel} or R_{final} based on a mathematical model or empirically. In such cases, we can define an equation as follows that optimises for more complex real world interactions:

$${arg min}_{{d}_{offset} , {r}_{wheel} , {R}_{final}} f ( {d}_{offset} , {r}_{wheel} , {R}_{final} )$$

where f is an objective function to be minimised, and may incorporate a combination of measures including, but not limited to:
The amplitude of the axial and radial run-out in the central steering shaft for each value of d_{offset}, r_{wheel} and R_{final}
The torque, power, energy or time required to steer the wheel for each value of d_{offset}, r_{wheel} and R_{final}
The stresses in the mechanisms when steering for each value of d_{offset}, r_{wheel} and R_{final}
The damage or wear to the ground or tyre when steering (e.g. soil compaction depth, tyre wear rate etc.) for each value of d_{offset}, r_{wheel} and R_{final}

Since typically the value of r_{wheel} and R_{final} will be limited or pre-defined, this equation can in many cases be simplified to:

$${arg min}_{{d}_{offset}} f ( {d}_{offset} )$$

In some embodiments, the radius of the wheel is considered as the unloaded radius. In other embodiments, the radius of the wheel is taken to be the loaded radius, whereby a specified amount of deformation expected for a given load is subtracted from the unloaded wheel radius. In some applications, the above equations need only be satisfied within some error margin (˜±10%) depending of the precision requirements and degree of flexibility in the operational environment. In some applications, the ground is expected to be largely composed of substantially solid matter (e.g. soil, road, concrete, grass, sand), but in other cases it may be of largely fluid matter (e.g. water, ocean surface). This has an impact on the allowable error margin between the ideal and actual system geometry parameters.

Advantageously, the base can be adapted for mounting to a chassis of a vehicle or other movable platform such as, for example, a self-propelled autonomous or robotic ground based vehicle, a personal transportation vehicle or wheelchair, an automobile, and the like. In some embodiments, two or more drive modules are mounted to the chassis to provide the vehicle or platform with desired characteristics in terms of stability, traction, power, ease of manoeuvrability, and the like. In various embodiments, the drive modules may be used for each wheel of the vehicle, or in conjunction with other ground engaging elements such as, for example, castors (fixed or rotatable), rollers, tracks, skids, etc. By way of example, in some embodiments, only a single drive module is required when used as a jockey wheel on a trailer or similarly otherwise constrained and stable vehicle. In some embodiments, a vehicle may employ at least two drive modules to provide holonomic motion for the vehicle, with additional castors (as a third or further wheel(s)) employed to provide stability to the vehicle. In some embodiments, each wheel of the vehicle is in the form of a drive module. In such embodiments, the vehicle employs at least three drive modules.

In some embodiments, the drive module need not be driven by a drive motor, and can simply be an unpowered steerable support wheel. Such embodiments may prove economical in applications where a relatively large number of wheels is required, for example in large structure transport vehicles (e.g. building, heavy vehicle, aeronautical or space vehicle transport).

Control of the drive module may be partly or fully automated as part of an overall environmental scanning, route planning, and targeting control methodology, optionally operating systematically in conjunction with a plurality of like or complementary autonomous vehicles.

In some embodiments, a chassis of the vehicle is configured to be a relatively rigid structure, thereby to enhance the structural integrity of the vehicle and to ease and simplify construction of a motion system employing the drive module. In other embodiments, various suspension elements (e.g. pneumatic, spring, hydraulic) may be incorporated or connected to one or more drive modules to provide dampening, shock absorption, wheel load averaging etc. Active or passive wheel load averaging mechanisms may also be used to equalise or control the ground forces of each wheel as part of a higher level optimisation. For example, in many cases, uniform wheel load averaging is ideal. In some embodiments, a detection system or means for detecting wheel loading (e.g. strain gauges, force/torque sensors, tire pressure etc) is used to provide feedback to an active load balancing control system by adjusting the heights of each drive module, either by adjusting the steering arm length or the entire drive module up/down. In some advanced embodiments, a means for detecting the chassis geometry deviations (e.g. by sensors, modelling etc.) is used as feedback for more accurate control of the steer and drive axes. Alternatively or in addition to this, in other embodiments, a constant or relatively fixed chassis geometry is assumed.

In one embodiment, the chassis is adapted to support one or more solar panels, to provide primary or supplementary electric power for the drive motors and thereby extend vehicle runtime. In some embodiments, the support platform is adapted for use as a launch pad for one or more other supplementary or autonomous vehicles such as UAVs, UGVs, AUVs or other tele-operable devices.

In some embodiments, the drive module includes components and systems whereby the vehicle is adapted to function autonomously or substantially autonomously, as an omni-directional mobile platform for a robot. Examples of such components and systems include:—
sensors suited to the intended application (such as ranging, imaging, localisation or inertial sensors),
actuators or instruments suited to the intended application (such as manipulators, robotic arms, pan/tilt mechanisms, agricultural planting, weeding, spraying or harvesting mechanisms, drilling or mining tools, firefighting tools including water nozzles or chemical sprayers, weapons systems, medical instruments or devices, research or analytical instruments or tools, or lifting and positioning tools for logistics or materials handling),
lighting systems (such as laser, UV, IR, LED or floodlighting systems),
energy generation or conservation equipment (such as solar panels, sails, wind turbines or fuel cells), and/or
ancillary electronic equipment (such as computers, data storage media, communications or navigation equipment, antennas or networking components).

In one embodiment, the drive module is adapted to support one or more robotic arms or other robotic devices. The platform may also be adapted for use as a launch pad for one or more other autonomous or supplementary support vehicles such as UAVs, UGVs, AUVs or other teleoperable devices.

According to another aspect of the invention, there is provided a steering arm for a swerve drive module, the steering arm including:

a support arm; and

a drive train supported by the support arm, the drive train being configured to provide a multi-stage drive reduction.

In other aspects, the invention provides an omni-directional vehicle having two or more drive modules as described herein.

In some embodiments, the drive module incorporates a traction control system or electronic stability control system. In those embodiments employing two or more drive modules, each traction or stability control system may be configured to either work in isolation in respect of each drive module, or in concert with all or predefined sets of drive modules in order to enhance or maximise in use the level of traction or stability for a driven vehicle.

In some embodiments, the drive module may incorporate a torque vectoring system that can work either in isolation in respect of each drive module, or in concert with all or predefined sets of drive modules in order to optimise the reaction force against the driven vehicle. For example, in one advanced implementation, each wheel may be independently driven and steered in order to optimise the performance of the vehicle (i.e. each drive module applying optimal reaction force to the vehicle body at each point in space and time). Furthermore, each of the steer and drive axes may operate one or more of a combination of selectively operable modes within the capabilities of the control system (e.g. torque, speed, power or position control modes). In some embodiments, the drive module may operate in any one or more of the four quadrants of the torque and velocity axes, which also allows for regenerative braking.

In some embodiments, strain gauges, force or torque sensors are fitted to the drive modules on at least one and preferably each wheel to close a feedback loop for actively maximising, optimising or monitoring tractive effort of the at least one or each drive module or as a whole system (e.g. particle model).

In some embodiments, the drive and steer axes are able to operate in any of current, torque, velocity, position, power or acceleration control modes as appropriate to the application.

In some embodiments, the drive module may incorporate a cleaning unit or means for cleaning the wheel as the wheel rotates in use. For example, the cleaning unit may include a scraper, scrubber, brush, cloth adapted to be placed in contact with or in close proximity to the wheel, preferably supported from the steering arm.

In some embodiments, the wheel is a gas filled rubber tyre. In other embodiments, the wheel may be of generally solid construction (e.g. rubber, metal, plastic etc).

In some embodiments, the wheel is of a generally fixed radius. In other embodiments, the radius of the wheel is variable. This can be due to suspension built into the wheel (e.g. by gas in the tire, passive flexures as part of the rim or tire elements). In some embodiments, the wheel offset is adjustable (manually or dynamically). In some embodiments, the wheel offset adjustment may be adapted so as to correspond or otherwise relate to a change in wheel radius (e.g. air pressure high/low, different wheels etc.).

In some embodiments, the entire drive module or central steering axis is nominally normal to the ground. In other embodiments, the drive module or central steering axis can be angled in order to achieve some performance advantage. For example, when the drive module is used in an automobile either the drive module or central steering axis can be angled to provide positive and/or negative camber in specific or all parts of the steering cycle.

In some embodiments, the system includes a means for locking or stopping the steering or drive axes (e.g. brakes, pins, fail safe magnetic brakes). This can be used for example in a low power or emergency fail case in some applications. The steering system is normally designed for continuous rotation, but in some cases there are steering limiters or end stops to limit the steering range where required by the particular application. In some cases there is a means for self-centring the steering axis to a predetermined position when power is removed (e.g. by magnetics, springs, cams etc).

In some embodiments, the system incorporates a mode to position and/or configure the steering of all wheels for aesthetics or maintenance (e.g. to change tires). In some embodiments, the system incorporates a mode to set the steering of all wheels to angles that lock the motion of the vehicle from rolling away through moving drive axes.

In some embodiments, the system incorporates a motion control system where the wheels are steered and driven in accordance with a typical ICR (instant centre of rotation) model. In other cases, the wheels are not steered to physically point to the ICR, for example when operating on slippery terrain. In this situation, the actual velocity vector (incorporating skidding) of each wheel nominally points perpendicular to the ICR.

In some cases the steering axis of multiple drive modules are mechanically linked (e.g. ackerman steering, double ackerman steering) in order to reduce the number of steer motors and feedback devices.

In some embodiments, the multiple stages of drive gear sets or the drive motor/gearhead are rotatably connected using rigid shafts, but in other embodiments flexible shafts (e.g. Bowden cables) can be used as substitutes or in conjunction to the rigid shafts.

In some embodiments, the gear sets are toothed gears (e.g. spur, helical etc). In other embodiments, the reduction unit includes other forms of reduction mechanisms, for example but not limited to pulleys, belts (synchronous or asynchronous), chains, friction based transmissions etc. Such reduction mechanism may be used in various combinations, including in combination with or without gears.

In some embodiments, the drive module incorporates one or more seals to substantially inhibit leakage of fluids (e.g. lubricating grease or oil, coolant etc.). In other cases, the drive module is largely a sealed enclosure with magnetic couplings for transferring drive or steer motion into or out of the module. These constructions provide enhanced durability and ruggedness when operating in extreme conditions such as through river crossing, muddy terrain etc.

In some embodiments, the tires are of sufficient volume to float a vehicle in a body of water. This allows the vehicle to be used as an omnidirectional amphibious or dedicated water borne vessel using wheels for both floatation and/or propulsion.

In some embodiments, the wheelbase or track width of a vehicle can be changed electronically by selectively swapping through the various combinations of wheels in or wheels out (with regards to the offset side in or out). This has applications in environments where there are constraints of the layout of the tire footprint, such as when traversing over wide gaps/obstacles, narrow regions of terrain, around obstacles (e.g. soil, plants and other objects) or troughs such as in controlled traffic farming.

In some embodiments, there is a bounding angular error margin for the steering position, and if the steering system is outside this zone then some action is taken (e.g. the steering of other modules stops or slows, drive axes of one or more modules stop or slow). The bounding angular error margin for the steering position may vary with some other aspect of the system (e.g. as the vehicle speeds up, the acceptable error margin becomes smaller). In some embodiments, a failure alert occurs when one or more steering axes is outside of the bounding operational zone.

In some embodiments, the tyre is relatively narrow and long to minimise the width of the ground contact patch. In other embodiments, various widths of tyres can be used as appropriate to the application.

In some embodiments, the tyre is of a relatively rounded cross section to apply more ground force at the centre of the contact patch than the edges. In other embodiments, flatter cross sections of the tyres can be used as appropriate to the application.

In some embodiments, there is a feature that automatically inflates/deflates tyres according to the conditions as sensed by the system. For example, muddy conditions may require a low tyre pressure to maintain traction and dry conditions may require a high tyre pressure to maintain efficiency. In such cases, the system can be interfaced with a traction control system, thereby to automatically optimise the pressure of each wheel (together or independently) an optimise one or more selected operating parameters (traction, efficiency, power etc) of the drive module.

In some embodiments, the drive module incorporates a second wheel that is steered only (e.g. passive or un-driven), and is coaxially aligned with the first wheel and positioned to the opposing side of the steering arm relative to the first (i.e. primary) wheel. In this case, the second wheel can be used for improved balance, improved load distribution, reduction of moment forces and/or improved aesthetics.

### BRIEF DESCRIPTION OF THE DRAWINGS

Preferred embodiments of the invention will now be described, by way of example only, with reference to the accompanying drawings in which:

FIG. 1 is a perspective view of a first embodiment of a drive module according to the invention;

FIG. 2 is a side view of the drive module of FIG. 1;

FIG. 3 is front view of the drive module of FIG. 1;

FIG. 4 is a cross-sectional view of the drive module taken along line A-A of FIG. 2;

FIG. 5 is an exploded perspective view of FIG. 1, showing the control unit, steering assembly and wheel in more detail;

FIG. 6 is a perspective view of an embodiment of a robotic ground based vehicle, incorporating four of the drive modules of FIG. 1;

FIG. 7 is a perspective view of an embodiment of a personal transportation vehicle/wheelchair, incorporating four of the drive modules of FIG. 1;

FIG. 8 is a perspective view of an embodiment an automobile, incorporating four of the drive modules of FIG. 1;

FIG. 9 is a perspective view of a second embodiment of a drive module according to the invention, in which the steering assembly incorporates dual concentric splines as part of a suspension mechanism;

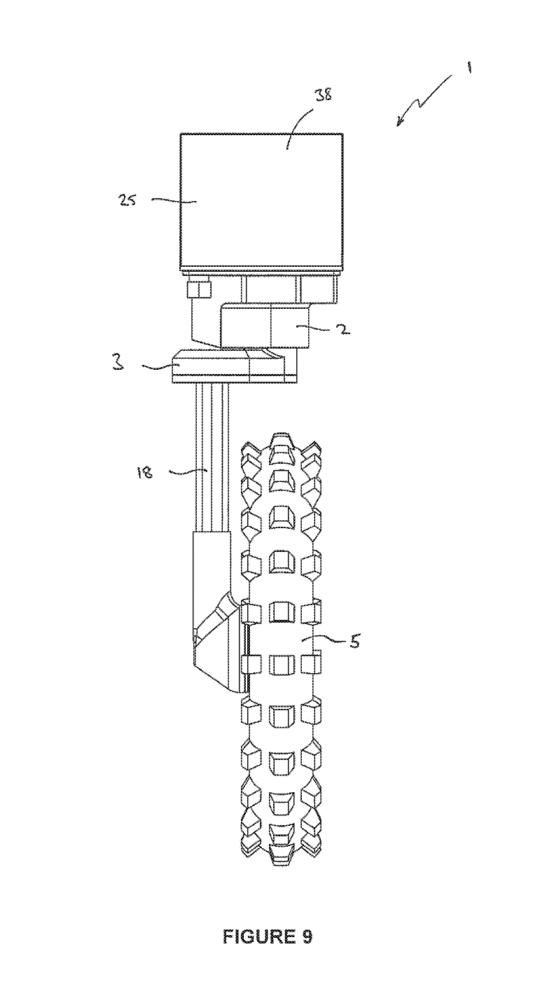

FIG. 10 is a cross-sectional view showing a part of another embodiment of a drive module according to the invention, in which the drive train includes a gear shifting mechanism associated with a drive input shaft;

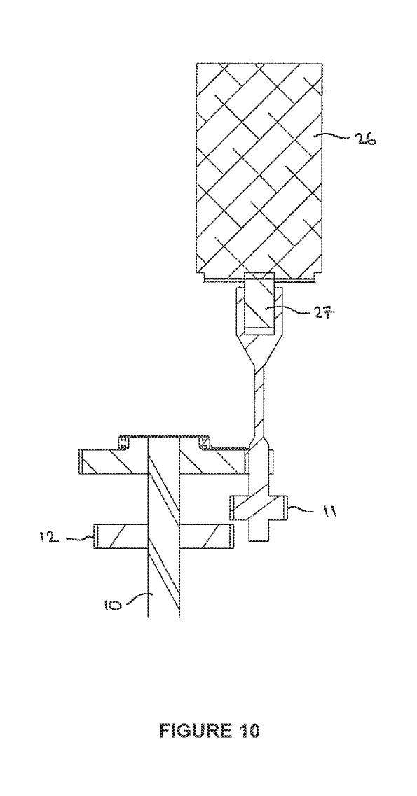

FIG. 11 is a cross-sectional view showing a part of another embodiment of a drive module, in which the drive train incorporates an additional intermediate gearset;

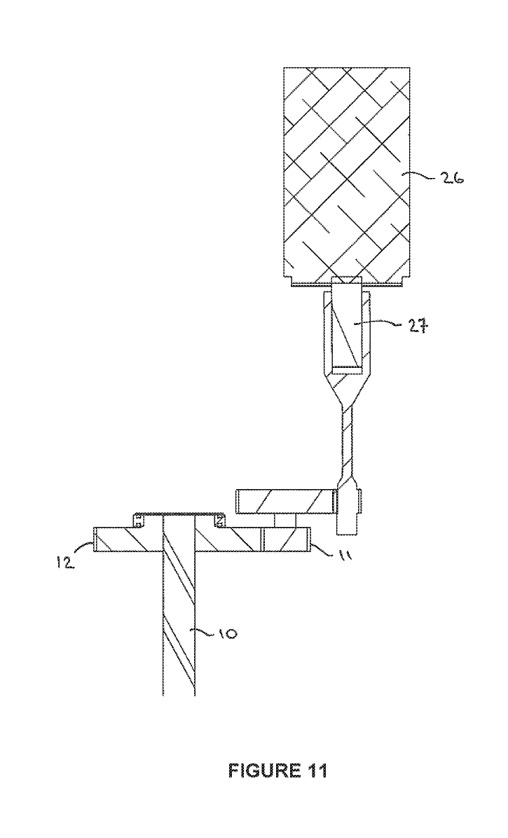

FIG. 12 is a cross-sectional view showing a part of another embodiment of a drive module according to the invention, in which the drive train incorporates a bevelled upper gear set and a non-parallel connecting shaft extending towards the wheel hub;

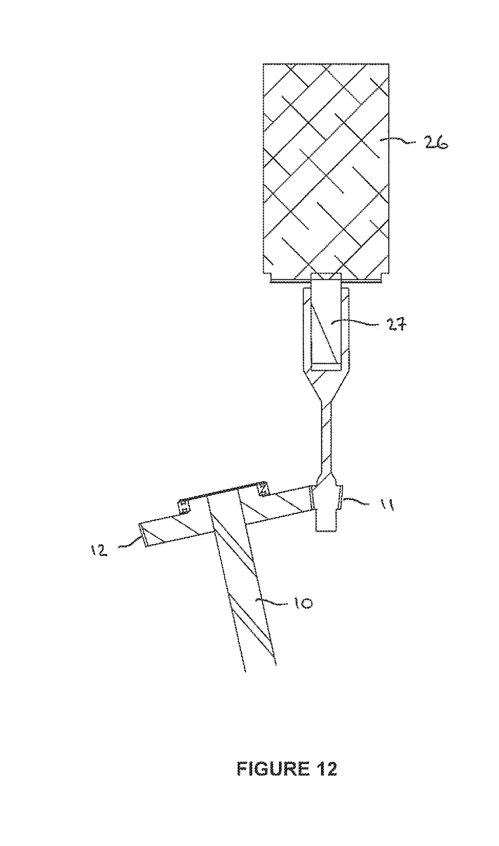

FIGS. 13A-13B show perspective views of embodiments of a steering assembly with details of the sign of the wheel offset for a given gearset configuration;

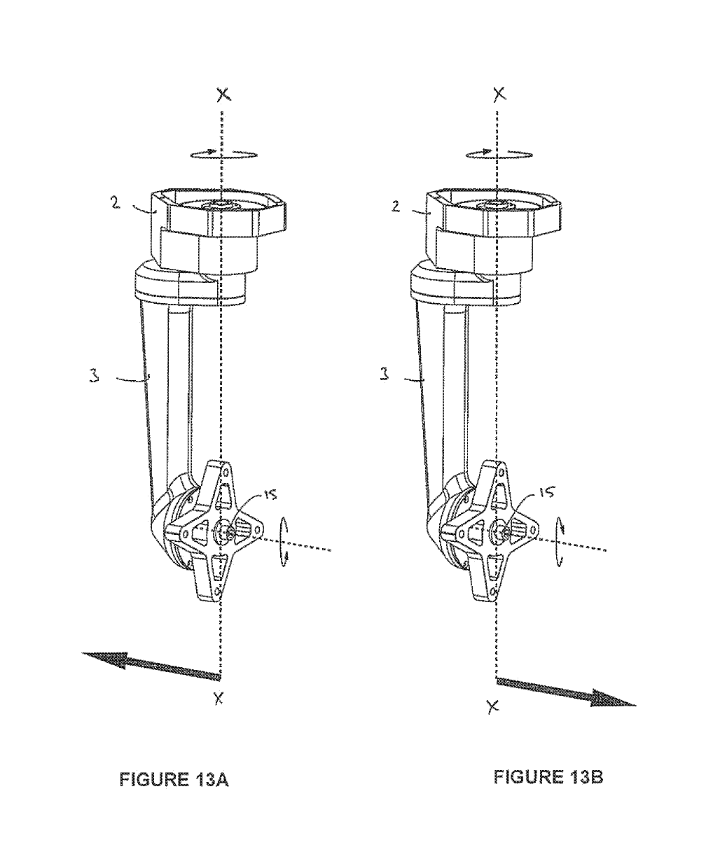

FIG. 14 is an exploded perspective view of the steering assembly of the drive module; and

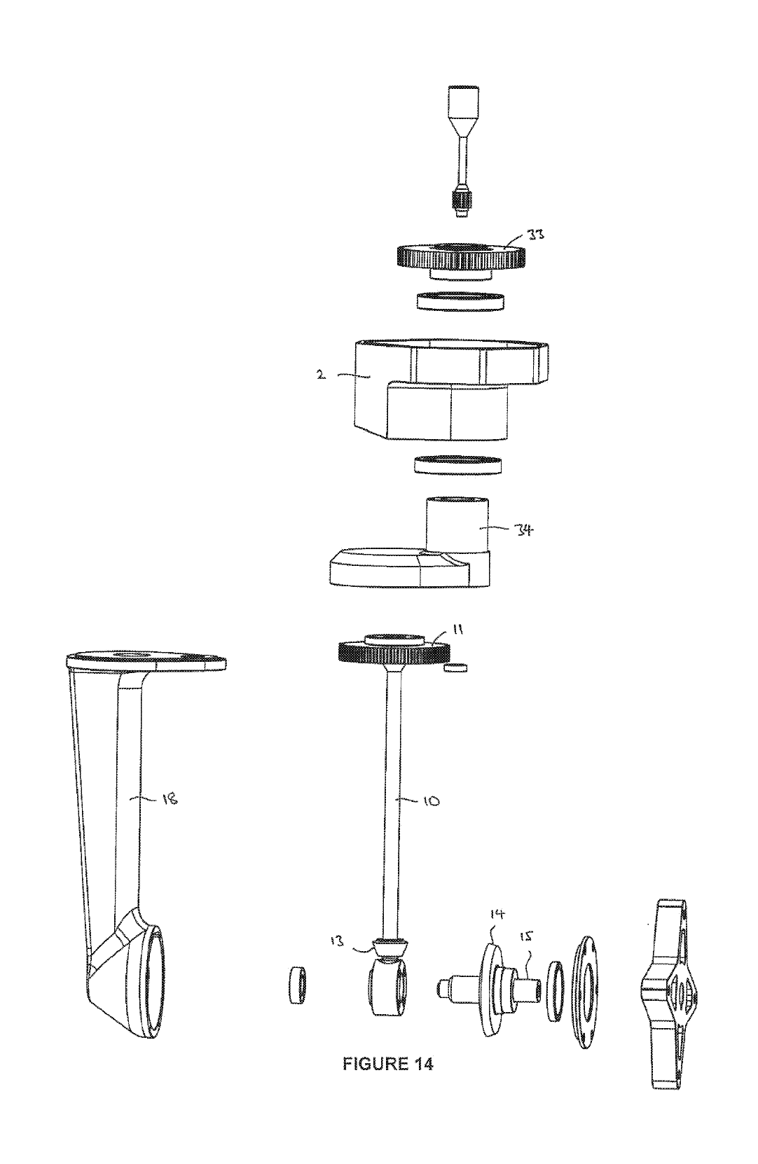

FIG. 15 is an enlarged cross-sectional view of a control unit of the drive module.

### PREFERRED EMBODIMENT OF THE INVENTION

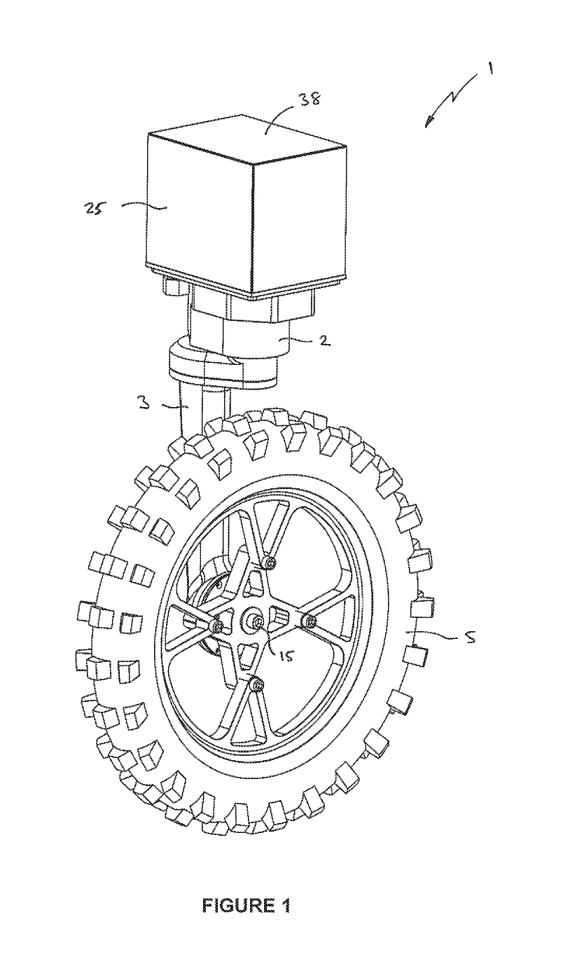

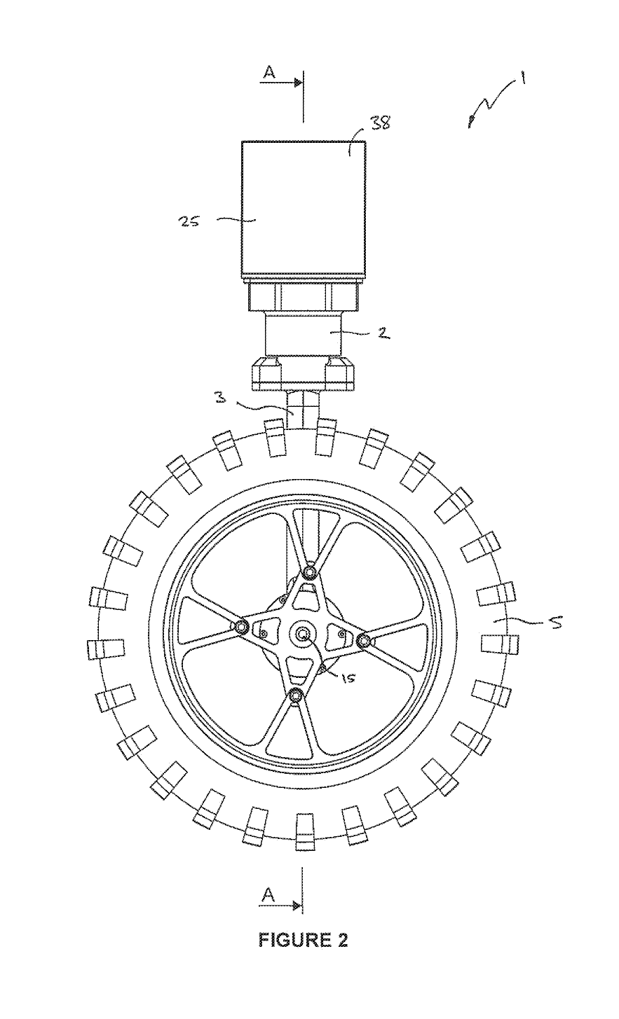

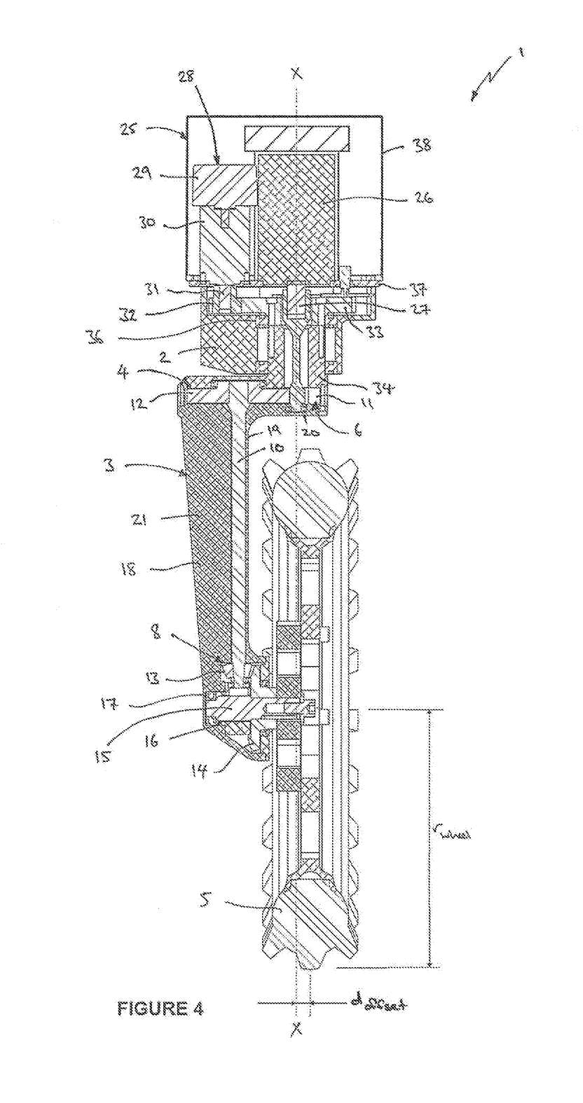

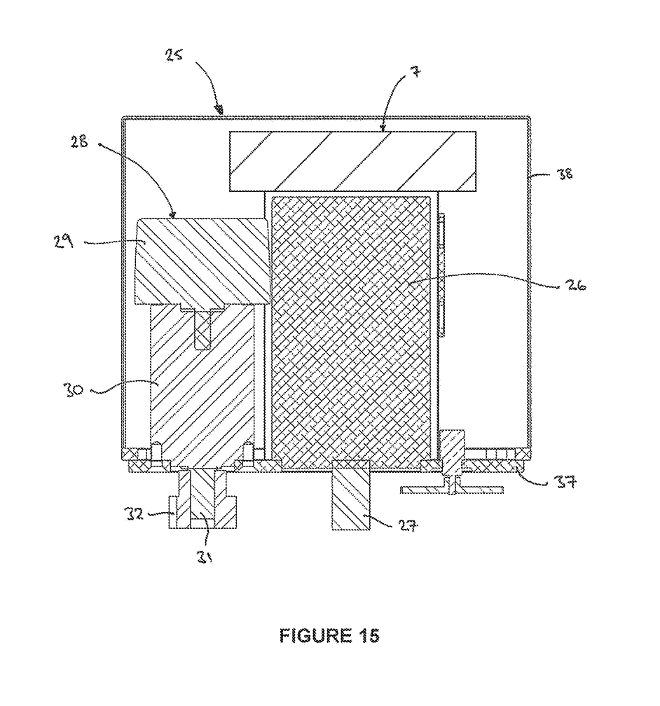

Referring initially to FIGS. 1 to 5, the invention in a first embodiment provides a drive module 1 including a base 2, a steering assembly 3 rotatably mounted to the base 2, a drive train 4 (FIGS. 4 and 15) carried by the steering assembly 3 which is selectively rotatable about a predetermined steering axis (“X-X”). In the illustrated embodiment, the drive train 4 is configured to provide a two-stage drive reduction, and is adapted to carry a wheel 5 such that a centre of a contact patch of the wheel is laterally offset from the steering axis (FIG. 4). The wheel 5 is advantageously formed of a suitable material and with a suitable profile to provide the wheel 5 with desired characteristics to suit the intended application, optionally incorporating integral treads or tyres as required for the intended application of the drive module 1.

The drive module 1 is in the form of a swerve drive unit having omni-directional functionalities and capabilities, in terms of both driving and steering actions. To provide the drive module 1 with omni-directional steering capabilities, the steering assembly 3 is mounted to the base 2 so as to be selectively rotatable through 360 degrees relative to the base 2 about the steering axis. The steering assembly 3 can rotate both in a clockwise direction and a counter-clockwise direction about the steering axis (when viewed from above) to steer the drive module 1 in a desired direction. It will be appreciated that the rotation of the steering assembly 3 about the steering axis causes a corresponding rotation of the wheel 5 about the steering axis such that the wheel rolls about its axis of rotation (e.g. as defined by a drive shaft).

The ability of the wheel 5 to roll around the steering axis (as opposed to skid) arises from the lateral offset of the wheel, whereby the wheel is advantageously positioned to the side of the line of travel of the wheel as defined by the centre of the contact patch of the wheel (when the vehicle is viewed from the front). As described in further detail below, this characteristic of the swerve drive module 1 is particularly advantageous when only a steering input is provided to the drive module (i.e. when there is no driving input). In addition, the mechanical decoupling of the steering and driving axes allows independent control of the steering and driving axes without the need for controller based decoupling throughout the entire controllable driving and steering axis velocity range.

In the illustrated embodiment, as best seen in FIG. 4, the drive train 4 carried by the steering assembly 3 is a reduction mechanism in the form of a mechanical gear arrangement configured to provide the two-stage drive reduction. The drive train 4 has a first (top) gear set 6 associated with and arranged to be driven by an input driving actuator of a drive unit 7. The first gear set 6 is in the form of a pair of spur gears and provides a first stage drive reduction of the drive train 4.

The drive train 4 includes a second (bottom) gear set 8 having a pair of bevel gears arranged and configured to be rotatably driven by the first (top) gear set 6. The second gear set 8 provides a second stage drive reduction of the drive train 4. In the illustrated embodiment, the second gear set 8 is directly driven by the first (top) gear set 6 by way of a connecting rod 10 extending between the first and second gear sets (6, 8).

The first (top) gear set 6 has a pair of spur gears including a first spur gear 11 meshingly engaged with a second spur gear 12 such that rotation of the first spur gear 11 in a first direction causes a corresponding rotation of the second spur gear 12 in an opposed second direction.

The axis of rotation of the first spur gear 11 is coaxially aligned with the axis of rotation of a driving actuator of the drive unit 7 and the steering axis about which the steering assembly 3 rotates in use to steer the drive module 1. In the cross-sectional view of FIG. 4, the first and second spur gears (11, 12) are mounted to the steering assembly such that each gear lies in a generally horizontal plane, with the steering axis extending in a generally vertical direction. In this layout of the first gear set 6, the axis of rotation of the first spur gear 11 is in parallel spaced apart relation to the axis of rotation of the second spur gear 12.

The second (bottom) gear set 8 includes a first bevel gear 13 arranged in parallel spaced apart relationship to the second spur gear 12 of the first gear set 6, and a second bevel gear 14 meshingly engaged with the first bevel gear 13. The second spur gear 12 is connected to the first bevel gear 13 by the connecting rod 10 such that these elements rotate in unison about the same vertical axis of rotation (i.e. an axis which is offset from and in parallel relation to the steering axis).

The second (bottom) gear set 8 is configured such that the axis of rotation of the second bevel gear 14 is orthogonal to the horizontal axis of rotation of the first bevel gear 13, and thus that of the connecting rod 10 and the second spur gear 8.

The first (top) gear set 6 has a first drive reduction ratio (R₁) determined by reference to the number of teeth on the first spur gear (n₁) and the number of teeth on the second spur gear (n₂). The second (bottom) gear set 8 has a second drive reduction ratio (R₂) determined by reference to the number of teeth on the first bevel gear (n₃) and the number of teeth on the second bevel gear (n₄).

The drive train 4 has an output driven member in the form of drive shaft 15 for supporting the wheel 5 for rotation. The drive shaft 15 is attached to and co-rotates with the second bevel gear 14 by actuation of the drive unit 7. The drive shaft 15 and the second bevel gear 14 are coaxially aligned with one another, and thus with the axis of rotation of the wheel 5. The drive shaft is connected to the second bevel gear and the wheel by a power transmission element such as a mechanical key (not shown) such that the draft shaft, the second bevel gear and the wheel co-rotate in unison about a common axis (i.e. the “wheel axis”).

The second bevel gear 14 has a bore 16 through which the drive shaft 15 extends such that a first end of the drive shaft 15 is adapted to support the wheel 5 and an opposed second end of the drive shaft 15 is supported by a bearing 17 mounted within the distal end of the steering assembly 15. In the illustrated embodiment, the drive shaft 15 advantageously extends through the bore 16 such that the first and second ends of the drive shaft 15 are positioned on opposite sides of the second bevel gear 14. Accordingly, the output/second bevel gear 14 of the drive train 4 is arranged between the connecting rod 10 and the wheel 5, thereby providing a compact arrangement to the drive module 1.

In the illustrated embodiments, the steering assembly 3 includes a single-sided rigid L-shaped steering arm 18 mounted for rotation relative to the base, to enable steering of the driving module 1. As best seen in FIG. 4, the steering arm 18 has a receiving formation in the form of an internal hollow cavity 19 in which the first and second gear sets (6, 8) and the connecting rod 10 of the drive train 4 are mounted. In this way, the steering arm 18 acts as a structural support for the drive train 4 to maintain the relative positioning and alignment of the various components of the drive train. The first gear set 6, the second gear set 8, and the connecting rod 10 of the drive train 4 are housed entirely within the steering arm 18 such that the steering arm 18 acts a cover for the drive train 4, protecting the geared mechanisms and inhibiting ingress of dust and debris.

The L-shaped steering arm 18 has a first arm 20 at its proximal end and adapted to be mounted in close proximity to the base, and a second arm 21 extending orthogonally from the first arm 20 to its distal end. The single-sided configuration of the steering arm 18 is such that the wheel 5 is supported to one side of the second arm 21 of the steering arm. It will be appreciated that the one-sided configuration of the steering arm 18 advantageously and readily facilitates mounting of the wheel 5 in the laterally offset position from the steering axis.

In the illustrated embodiment, the length of the first arm 20 is less than the length of the second arm 21. The length of the first arm 20 is fixed to facilitate the desired offset mounting position of the wheel 5, and to provide the drive module 1 a compact configuration.

The length of the second arm 21 can be set to accommodate the radius of the wheel and provide a desired clearance gap between the top of the wheel 5 and the first arm 20 and/or to provide a desired ground clearance for the particular terrain of the intended application of the drive module 1.

Referring to FIG. 4, the first gear set 6 is housed within the first arm 20 at the proximal end of the steering arm 18, and the second gear set 8 is housed towards the distal end of the second arm 21 of the steering arm 18, with the connecting rod 10 extending between the first and second gear sets along the second arm 21.

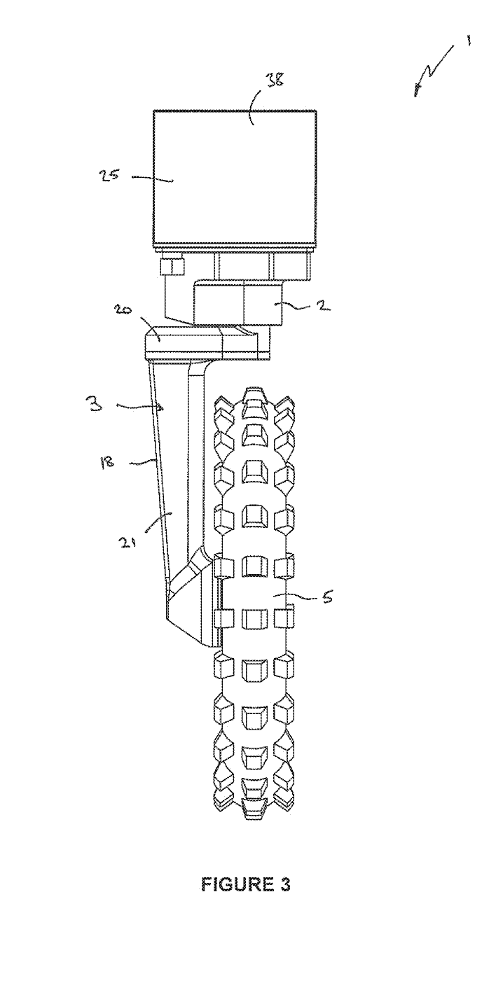

As is most clearly shown in FIGS. 3 and 4, the L-shaped configuration of the steering assembly, together with the associated stepped, staggered or otherwise offset arrangement of the drive train to complement the shape of the steering assembly, advantageously forms an open area or void about the steering axis, thereby ensuring that neither the steering assembly nor the drive train interfere with the wheel and thus do not determine the offset positioning of the wheel relative to the steering axis. In particular, the steering assembly and drive train do not interfere with the top and upper half portion of the wheel.

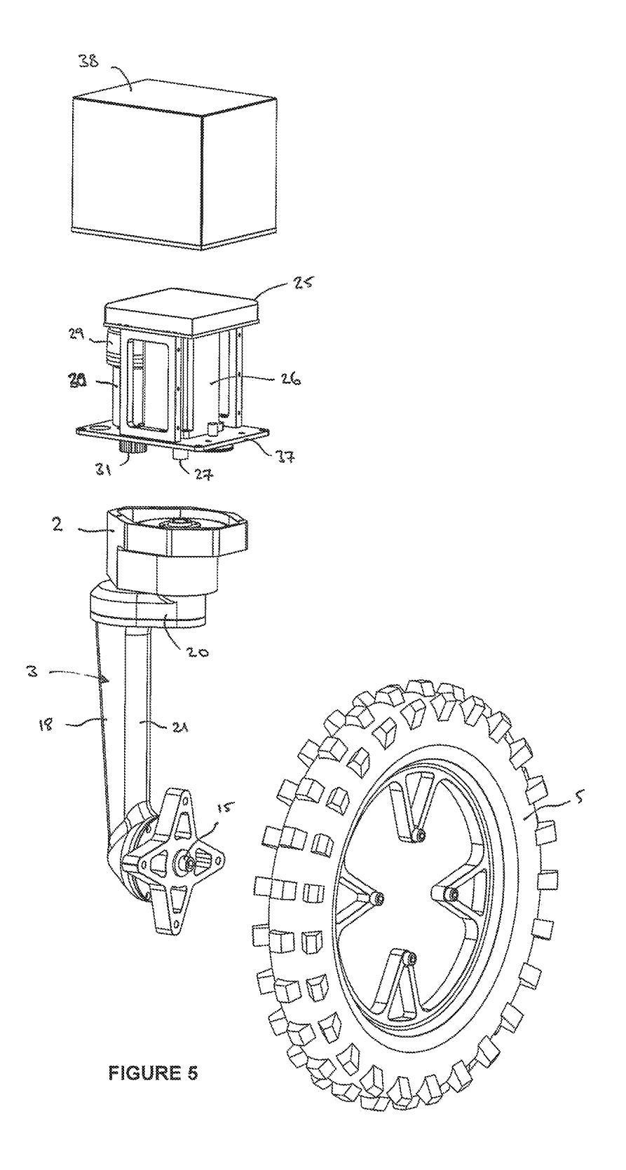

Referring to FIGS. 4 and 5, a control unit 25 is provided for selectively controlling movement of the drive train 4 and steering assembly 3, and thus the drive module 1 as a whole. As foreshadowed, the control unit 25 has a drive unit 7 for controlling movement of the drive train 4. The drive unit 7 includes a driving actuator in the form of an electric drive motor 26 for providing drive inputs to the drive train 4 to rotate the wheel 5 and thereby propel the drive module 1 in a forwards or a reverse direction as required.

The drive motor 26 has a drive motor shaft 27 which is coaxially aligned with, and operatively connected to, the first spur gear 11 of the first (top) gear set 6. By this arrangement, activation of the drive motor 26 will rotate the drive motor shaft 27 and cause a corresponding rotation of the first spur gear 6, and thus the wheel 5 via the drive train 4 to propel the drive module 1.

For self-propelled autonomous applications of the drive module, the drive unit 7 preferably includes computerised control modules, power regulators and/or associated electronic components, operating in accordance with predetermined drive control algorithms and methodologies, to control the velocity and acceleration of the drive motor 26.

In addition to the driving unit 7, the control unit 5 has a steering module 28 for selectively controlling movement of the steering arm 18. The steering module 28 includes a steering actuator in the form of an electric steering motor 29 adapted to provide steering inputs to control inputs to the steering assembly to steer the wheel 5 in a left or right direction as required, in use. To provide greater flexibility and control over the range of control inputs that can be applied to the drive module, the drive unit 7 and the steering module 28 are advantageously independently operated such that the driving unit 7 can provide driving inputs whilst the steering module 28 is in an inactive state. Similarly, the steering module 28 can provide steering inputs whilst the driving unit 7 is in an inactive state.

In the illustrated embodiment as best seen in FIG. 4, the steering module 28 includes a reduction gearbox 30 associated with the steering motor 29. The reduction gearbox 30 of the steering module 28 has a steering shaft 31 for driving a steering gear mechanism to control movement (rotation) of the steering assembly 3.

The steering gear mechanism is arranged within the base 2 of the drive module 1, and is adapted to provide a further drive reduction to facilitate selective and precise control of the steering assembly 3. In the illustrated embodiment, the steering gear mechanism includes a pair of steering spur gears mounted in intermeshing engagement so as to rotate in opposite direction to each other. The pair of steering spur gears includes a first steering gear 32 and a second steering gear 33.

The first steering gear 32 is operatively coupled to the steering shaft 31 such that, upon activation of the steering motor 29, rotation of the steering shaft 31 causes a corresponding rotation of the first steering gear 32. The second steering gear 33 is driven by the first steering gear 32 in an opposite direction to the first steering gear 32 and is operatively coupled to the steering assembly 3 to cause a corresponding movement thereof.

The second steering gear 33 is connected to the first arm 20 of the steering arm 18 by a hollow tubular coupling element 34. The tubular coupling element 34 is fixedly connected (directly or indirectly) at its proximal end to the second steering gear 33 by suitable connecting elements or fasteners (e.g. screws) and at its distal end to the first arm 20 of the L-shaped steering arm 18. In this way, the second steering gear 33, the coupling element 34, and the steering arm 18 form an interconnected unit in which all components rotate in unison about the steering axis upon activation of the steering motor 29.

The second steering gear 33 and the coupling element 34 are mounted within a hollow interior space of the base 2 so as to be coaxially aligned with the steering axis (i.e. as defined by the drive motor shaft 27). The coupling element 34 is in the form of a hollow tubular member having a passage through which the connecting member of the drive module passes (to couple the drive motor shaft 27 to the first spur gear 11), thereby facilitating the coaxial alignment of the various components with the steering axis.

The base 2 has an open passageway 35 defined about the steering axis and arranged to allow the tubular coupling element 34 of the steering module 28 to pass therethrough. Two friction reducing elements in the form of roller bearings 36 are mounted within the open passageway to facilitate the relative rotation between the base 2 and the coupling element/steering assembly upon activation of the steering motor.

For self-propelled autonomous applications of the drive module 1, the steering module 28 includes computerised control modules, power regulators, feedback encoders and/or associated electronic components, operating in accordance with predetermined steering control algorithms and methodologies.

With reference to FIG. 5, the various components of the drive unit 7 and the steering module 28 are mounted to a mounting board 37 so as to form a control unit 38 which can be releasably mounted to the base 2 by suitable fastening means (e.g. screws). A protective cover 38 is detachably mountable over the control unit.

The lateral offset between the steering axis and the centre of the contact patch of the wheel advantageously allows the wheel to roll when the steering assembly is rotated about the steering axis when the drive motor 26 is inactive and no drive input is applied to the wheel via the drive train (any braking mechanism is released such that wheel is free to rotate about its drive axis).

It has been found that the following general kinematic equation can be applied to the reduction gear train carried by the steering arm in order to calculate the preferred offset between the steering axis and the centre of the contact patch of the wheel. That is, the follow general equation can be advantageously be used to define the system geometry for the gearset configuration of the drive train and steering assembly:

$$\frac{{d}_{offset}}{{r}_{wheel}} == {\prod }_{i = 1}^{{n}_{gearsets}} \frac{{n}_{teeth \_ i \_ input}}{{n}_{teeth \_ i \_ outpu t}} = {R}_{final}$$

where:
d_{offset} is the offset between the steering axis and the centre of the contact patch of the wheel
r_{wheel} is the radius of the wheel
n_{gearsets} is the number of gearsets mounted on the steering assembly and is equal to or greater than 1 (i.e. n_{gearsets}−1)
n_{teeth_i_input} is the number of teeth on the ith gearsets input gear
n_{teeth_i_output} is the number of teeth on the ith gearsets output gear
R_{final} is the final speed ratio of the multi-gearset configuration

Where the drive train includes a multi-stage drive reduction having two or more stages of drive reduction, the number of gearsets is equal to or greater than 2 as follows:
n_{gearsets} is the number of gearsets mounted on the steering assembly and is equal to or greater than 2 (i.e. n_{gearsets}≥2)

It is to be noted that, in the above equation, n_{gearsets} defines the number of gearsets that are actually mounted to the steering assembly. Any auxiliary gearsets that are mounted to the non-steered mount point of the drive module are independent of the system geometry and are not used in the above equation.

In the illustrative example of a drive train having two gear sets, the above general equation can be expressed as follows:

$$\frac{{d}_{offset}}{{r}_{wheel}} = \frac{{n}_{teeth \_ 1 \_ input}}{{n}_{teeth \_ 1 \_ outpu t}} \times \frac{{n}_{teeth \_ 2 \_ input}}{{n}_{teeth \_ 2 \_ outpu t}}$$

In practical applications, however, there may be a number of imperfections and nonlinearities (e.g. in the tyre to ground interaction, manufacturing errors, tyre deformation etc.) which could give rise to additional factors that may need to be considered following application of the above simple kinematic equations in practice. For example, with a given wheel construction with an estimated or predicted degree of deformation, the above formula could be modified or approximated to account for a difference between unloaded and loaded radius values, where the radius of the wheel in the formula is taken to be the loaded radius. That is, in the above formula, r_{wheel} may be replaced with:

r_{loaded}=r_{unloaded}−y_{deformation}
where y_{deformation} is the estimated deformation of the wheel.

In some cases, an empirical determination of the system geometry based on experimentation and measurement, in conjunction with the above formula, may produce more practical results for implementation. Accordingly, it may be preferred in some cases to choose or refine the system geometry values d_{offset}, r_{wheel}, or R_{final} based on a mathematical model or empirically. In such cases, we can define an equation as follows that optimises for more complex real world interactions:

$${arg min}_{{d}_{offset} , {r}_{wheel}} f ( {d}_{offset} , {r}_{wheel} , {R}_{final} )$$

where f is an objective function to be minimised, and may incorporate a combination of measures including, but not limited to:
The amplitude of the axial and radial run-out in the central steering shaft for each value of d_{offset}, r_{wheel} and R_{final}
The torque power, energy or time required to steer the wheel for each value of d_{offset}, r_{wheel} and R_{final}
The stresses in the mechanisms when steering for each value of d_{offset}, r_{wheel} and R_{final}
The damage or wear to the ground or tyre when steering (e.g. soil compaction depth, tyre wear rate etc.) for each value of d_{offset}, r_{wheel} and R_{final}

Since typically the value of r_{wheel} and R_{final} will be limited or pre-defined, this equation can in many cases be simplified to:

$${arg min}_{{d}_{offset}} f ( {d}_{offset} )$$

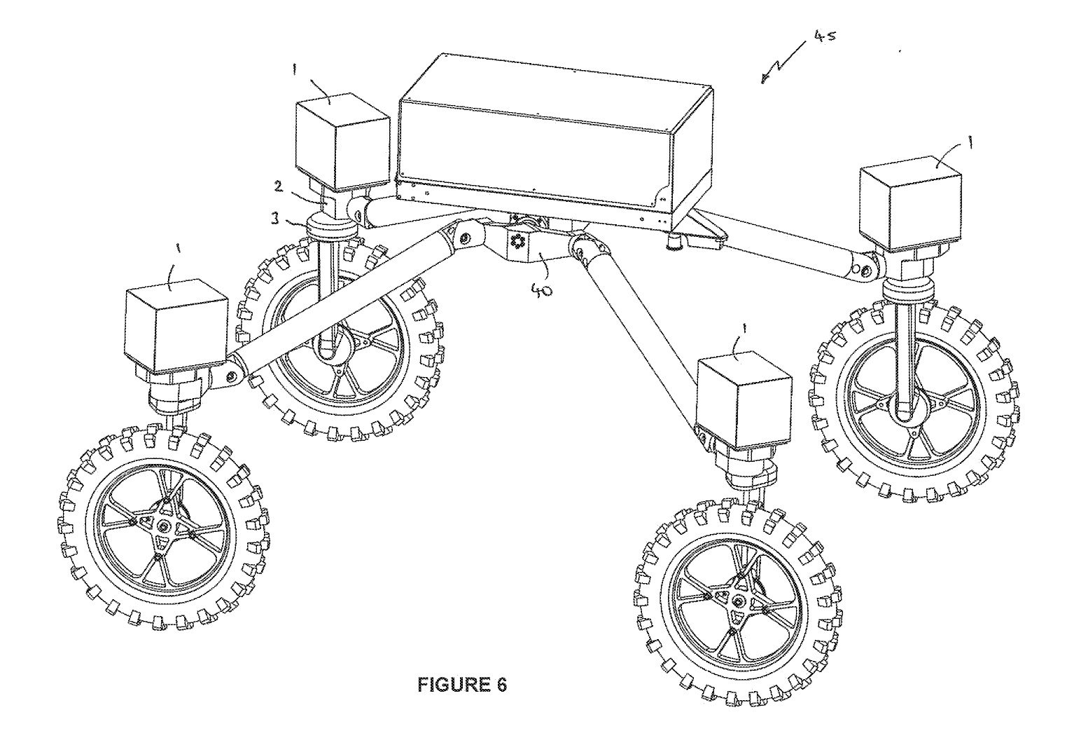

FIG. 6 shows a further embodiment of the invention, in which four of the drive modules of FIGS. 1 to 5 are mounted to a chassis 40 to form a self-propelled autonomous robotic ground based vehicle 45.

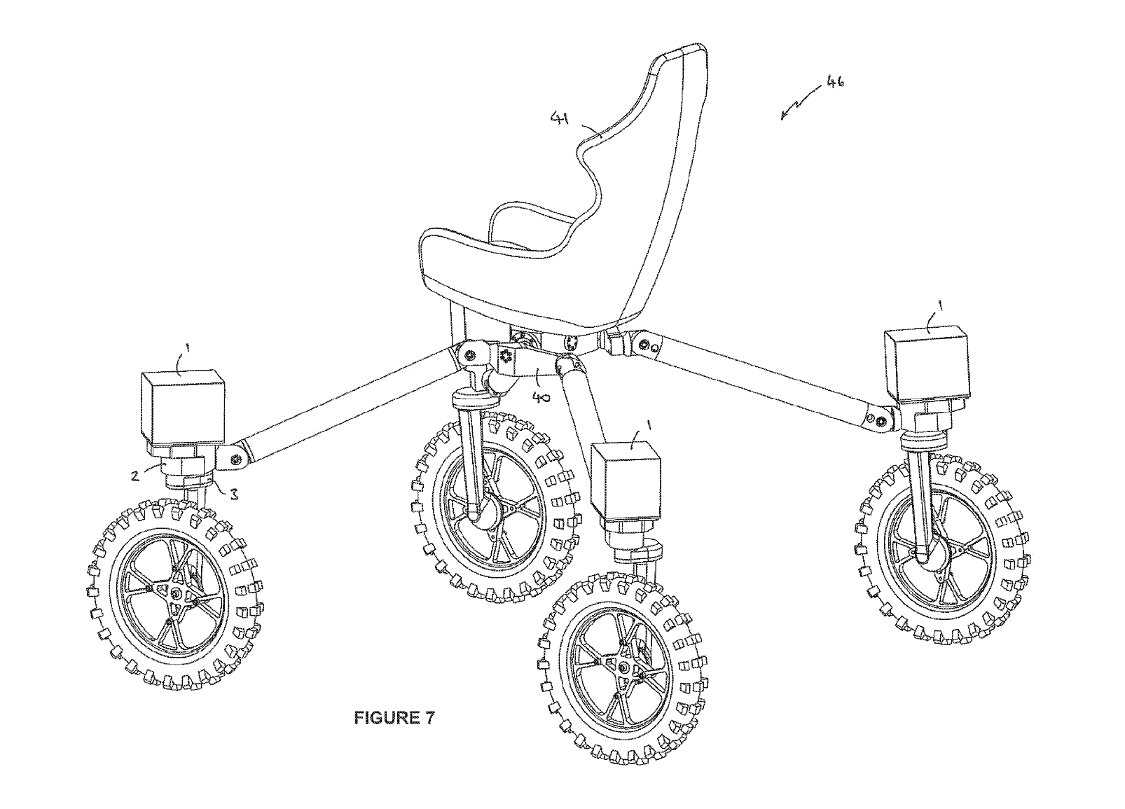

FIG. 7 shows a further embodiment of the invention, in which four of the drive modules of FIGS. 1 to 5 are mounted to a chassis 40 with a chair 41 to form a, a personal transportation vehicle or wheelchair 46.

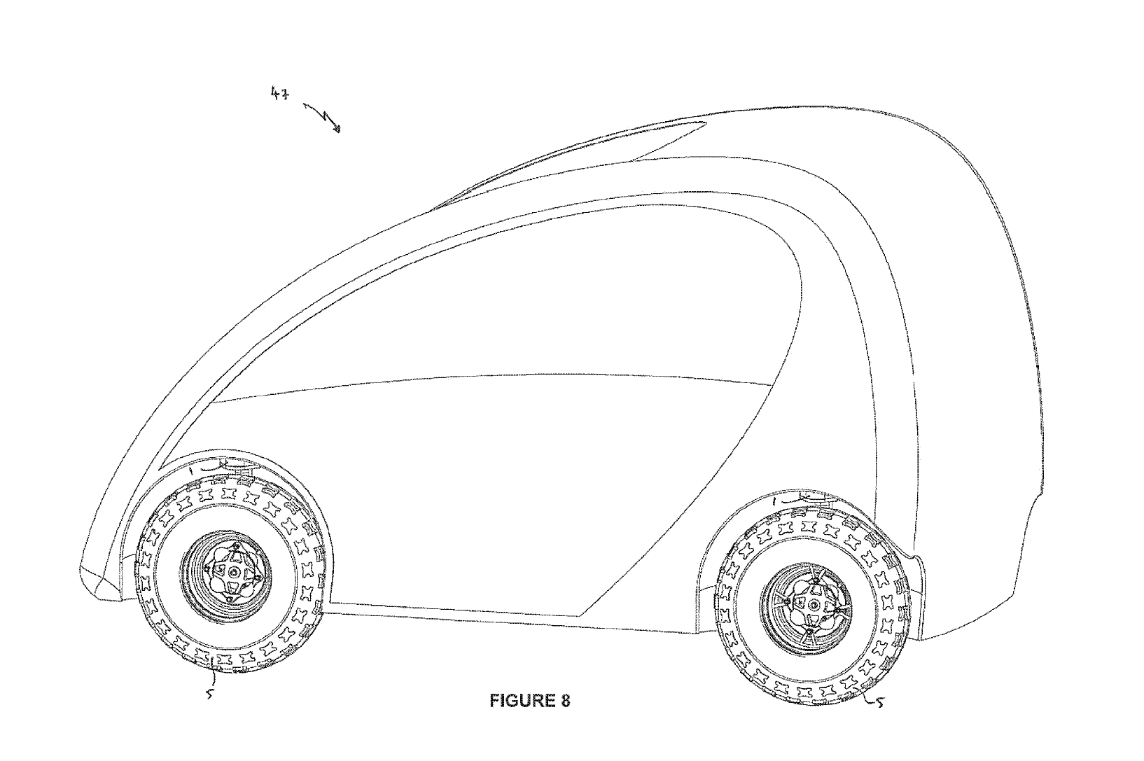

FIG. 8 shows a further embodiment of the invention, in which four of the drive modules of FIGS. 1 to 5 are mounted to a chassis 40 to form an automobile 47.

In further embodiments, one or more additional wheels may be incorporated between, in front of or behind the drive modules for stability, supplementary drive capacity, additional load bearing capacity, or other specific purposes. Any such additional wheels may be driven or free-wheeling, and may optionally incorporate steering mechanisms. In one particular variation, one or more additional wheels are supported for rotation on a common axis, either inboard or outboard of the wheels of the drive modules.

Control of the drive modules may be partly or fully automated as part of an overall environmental scanning, route planning, and control methodology, optionally operating systematically in conjunction with a plurality of like or complementary autonomous vehicles.

In one embodiment, the chassis is adapted to support one or more solar panels, to provide primary or supplementary electric power for the drive and steering motors and thereby extend vehicle runtime. In some embodiments, the chassis may have a support platform mounted thereon and adapted for use as a launch pad for one or more other supplementary or autonomous vehicles such as UAVs, UGVs, AUVs or other teleoperable devices.

In some embodiments, the drive module includes components and systems whereby the vehicle is adapted to function autonomously or substantially autonomously, as an omni-directional mobile platform for a robot. Examples of such components and systems include:—
sensors suited to the intended application (such as ranging, imaging, localisation or inertial sensors),
actuators or instruments suited to the intended application (such as manipulators, robotic arms, pan/tilt mechanisms, agricultural planting, weeding, spraying or harvesting mechanisms, drilling or mining tools, firefighting tools including water nozzles or chemical sprayers, weapons systems, medical instruments or devices, research or analytical instruments or tools, or lifting and positioning tools for logistics or materials handling),
lighting systems (such as laser, UV, IR, LED or floodlighting systems),
energy generation or conservation equipment (such as solar panels, sails, wind turbines or fuel cells), and/or
ancillary electronic equipment (such as computers, data storage media, communications or navigation equipment, antennas or networking components).

In various embodiments, the drive module could advantageously be employed in, but not limited to, the following types of vehicles:
Mining and Construction: Trucks, loaders, tractors, forklifts, bulldozers, cranes, graders, draglines, haul trucks, excavators, tunnel-boring machines, scissor lifts
Defence/Military: personnel carriers, tanks, target training vehicles, bomb disposal robots
Agricultural Vehicles: tractors, agricultural robots
Space: planetary rovers, shuttle transporters
Stevedoring: straddle carriers, container transporters
Transport: cars, trucks, buses
Logistics: warehouse transport vehicles and robots
Aquatic: amphibious or surface vehicles
Motorsport: racing vehicles
Aerospace: landing gear or motion systems on aerial vehicles or aerial vehicle handling vehicles (e.g. pushback tractors or tugs)
Personal Mobility: wheelchairs, scooters, skateboards, utility vehicles
Medical: Patient beds, mobile assisted patient rehabilitation walking vehicles (e.g. with a harness), surgical or monitoring equipment vehicles
Other: Generic robotic bases, telepresence robots.

It will be appreciated that the invention in its various preferred embodiments provides a drive module with a number of inherent and unique features and advantages. In particular, the ability to determine the extent of wheel offset by way of a generalised kinematic equation significantly reduces the time associated with designing, testing and developing swerve drive units for various applications. In addition, the ability to apply this system geometry to modules incorporating multistage reduction drives housed within a steering assembly provides improvements in the degree of accuracy of control, in particular during low speed applications.

Furthermore, the use of multi-stage reduction drives within the steering assembly advantageously obviates the need for additional and often bulky gearboxes associated with the drive motor, as relatively large gear reductions can be obtained through the drive train. This in turn results is a relatively compact system geometry having a reduced foot print, and provides a drive module which is robust and relatively simple to construct and is scalable. The use of a single-sided steering arm improves access to the wheel and thus gives rise to ease of service, maintenance, and repair.

The use of multi-stage reduction drives within the steering assembly is also advantageous over single reduction drives since they allow for the wheel to be located closely to the steer rotation axis which minimises the swept volume of the steering wheel, reduces moment loads on mechanical components, reduces the steering or steer holding torque requirements, provides a near constant footprint geometry and allows for greater clearances between the sidewall of the tyre and the supporting mechanics. This arrangement can also assist in providing a better balance in the design of swerve drive units, particularly between the requirement of a changing vehicle footprint and large swept volume of the steering wheel against that of smooth, efficient and simple operation of the system. In these and other respects, the invention represents a practical and commercially significant improvement over the prior art.

Although the invention has been described with reference to specific examples, it will be appreciated by those skilled in the art that the invention may be embodied in many other forms.

1. A drive module, including:
a base;
a steering assembly mounted to the base and selectively rotatable about a steering axis;
a drive train carried by the steering assembly; and
a wheel operatively associated with the drive train;
wherein at least a portion of the steering assembly and the drive train is spaced from the steering axis, thereby to form a void about the steering axis in which the wheel can be mounted.

2. (canceled)

3. A drive module according to claim 1, wherein the drive train provides a multi-stage drive reduction.

4-8. (canceled)

9. A drive module according to claim 1, wherein an auxiliary drive reduction mechanism is provided between a driving actuator and the drive train carried by the steering assembly.

10. A drive module according to claim 1, wherein the drive train includes a first gear set having a pair of spur gears arranged and configured to be rotatably driven by a driving actuator, wherein the first gear set includes a first spur gear meshingly engaged with a second spur gear, the axis of rotation of the first spur gear is coaxially aligned with the axis of rotation of the driving actuator, thereby to define the steering axis about which the steering assembly rotates.

11-12. (canceled)

13. A drive module according to claim 4, wherein the drive train includes a second gear set having a pair of gears arranged and configured to be rotatably driven by the first gear set, the second gear set includes a bevel gear set, wherein a connecting rod extends between the second spur gear of the first gear set and a first bevel gear of the second gear set, wherein the second spur gear, the connecting rod and the first bevel gear are arranged rotate in unison about a common axis.

14-15. (canceled)

16. A drive module according to claim 5, wherein the first gear set has a first drive reduction ratio (R₁) and the second gear set has a second drive reduction ratio (R₂).

17. A drive module according to claim 5, wherein the first drive reduction ratio of the first gear set is greater than or equal to the second drive reduction ratio of the second gear set.

18. A drive module according to claim 5, wherein the first drive reduction ratio of the first gear set is less than or equal to the second drive reduction ratio of the second gear set.

19-20. (canceled)

21. A drive module according to claim 1, wherein the wheel is mounted to the drive train such that a centre of a contact patch of the wheel is laterally offset from the steering axis, wherein the offset between the steering axis and the centre of the contact patch of the wheel is determined by the following equation:
$$\frac{{d}_{offset}}{{r}_{wheel}} = {\prod }_{i = 1}^{{n}_{gearsets}} \frac{{n}_{teeth \_ i \_ input}}{{n}_{teeth \_ i \_ outpu t}} = {R}_{final}$$
where:
d_{offset} is the offset between the steering axis and the centre of the contact patch of the wheel
r_{wheel} is the radius of the wheel
n_{gearsets} is the number of gearsets mounted on the steering assembly and is equal to or greater than 1 (i.e. n_{gearsets}≥1)
n_{teeth_i_input} is the number of teeth on the ith gearsets input gear
n_{teeth_i_output} is the number of teeth on the ith gearsets output gear
R_{final} is the final speed ratio of the multi-gearset configuration

22. A drive module according to claim 1, wherein the steering assembly includes a steering arm mounted for rotation relative to the base.

23. A drive module according to claim 10, wherein the steering arm has a receiving formation in which the drive train can be mounted, whereby the steering arm acts as a mechanical support for the drive train to maintain the relative positioning and alignment of the drive train components.

24. A drive module according to claim 10, wherein the steering arm is adapted to support the wheel to one side of the steering arm, wherein the steering arm has an asymmetrical profile, thereby to facilitate the lateral offset of the contact patch of the wheel from the steering axis.

25. (canceled)

26. A drive module according to 10, wherein the length of the steering arm and/or connecting rod is selectively adjustable.

27. A drive module according to claim 1, including a control unit is-provided for selectively controlling movement of the drive train and steering assembly, wherein the control unit includes a drive system for controlling movement of the drive train, the drive system including a driving actuator adapted to provide drive inputs to the drive train, thereby propelling the wheel in a forwards or a reverse direction.

28. (canceled)

29. A drive module according to claim 14, wherein the control unit includes a steering module for selectively controlling movement of the steering assembly, the steering module including a steering actuator adapted to provide steering inputs to the steering assembly, thereby steering the wheel in a left or right direction.

30. A drive module according to claim 15, wherein the steering module includes a reduction gearbox associated with the steering motor, the reduction gearbox of the steering module having a steering shaft for driving a steering gear mechanism, thereby to control movement of the steering assembly.

31. A drive module according to claim 16, wherein the steering gear mechanism is arranged within the base and adapted to provide a further drive reduction to facilitate control of the steering assembly.

32. A drive module according to claim 17, wherein the steering gear mechanism includes a pair of steering spur gears mounted in intermeshing engagement so as to rotate in opposite direction to each other, the pair of steering spur gears including a first steering gear operatively coupled to the steering shaft such that, upon activation of the steering motor, rotation of the steering shaft causes a corresponding rotation of the first steering gear, and a second steering gear driven in an opposite direction to the first steering gear, wherein the second steering gear is operatively coupled to the steering assembly to cause a corresponding movement thereof.

33. (canceled)

34. A drive module according to claim 18, wherein the second steering gear is connected to the steering assembly by a coupling element, the coupling element being fixedly connected at one end to the second steering gear and at its other end to the steering assembly, whereby the coupling element and the steering assembly form an interconnected unit in which all components rotate in unison about the steering axis upon activation of the steering motor.

35-36. (canceled)

37. A drive module according to claim 1, wherein rotation of the steering assembly about the steering axis causes a corresponding rotation of the wheel about the steering axis such that the wheel rolls about its axis of rotation.

38. (canceled)
